(19) United States
(12) Patent Application Publication
(10) Pub. No.: US 2025/0138223 A1
(43) Pub. Date: May 1, 2025

(54) ANTI-REFLECTIVE LAMINATE

(71) Applicant: AGC Inc., Tokyo (JP)

(72) Inventors: Kazuma YOSHIDA, Tokyo (JP); Hideaki TAKAHOSHI, Tokyo (JP); Kazuya TAKEMOTO, Tokyo (JP); Kaname SETO, Tokyo (JP)

(73) Assignee: AGC Inc., Tokyo (JP)

(21) Appl. No.: 18/925,710

(22) Filed: Oct. 24, 2024

(30) Foreign Application Priority Data
Oct. 31, 2023 (JP) 2023-186576

(51) Int. Cl. G02B 1/11

(52) U.S. Cl. CPC G02B 1/11

(57) ABSTRACT

An anti-reflective laminate includes: a substrate; and an anti-reflective layer having a four-layer structure including a first refractive index layer, a second refractive index layer, a third refractive index layer, and a fourth refractive index layer. The first refractive index layer has a refractive index of 1.25 to 1.50, the second refractive index layer has a refractive index of 1.50 to 2.40, the third refractive index layer has a refractive index of 2.25 to 2.45, and the fourth refractive index layer has a refractive index of 1.25 to 1.50. The first refractive index layer has a thickness of 40 to 105 nm, the second refractive index layer has a thickness of 60 to 90 nm, the third refractive index layer has a thickness of 80 to 110 nm, and the fourth refractive index layer has a thickness of 70 to 100 nm.

### CROSS-REFERENCE TO RELATED APPLICATIONS

This application claims priority from Japanese Patent Application No. 2023-186576 filed on Oct. 31, 2023, the entire subject matter of which is incorporated herein by reference.

### TECHNICAL FIELD

The present invention relates to an anti-reflective laminate.

### BACKGROUND ART

In the related art, in order to improve the visibility of an image display device, an anti-reflective laminate such as an anti-reflective film has been provided on an image display surface. The anti-reflective laminate is designed to reduce reflection over the entire visible light wavelength range, and is, for example, known to have a high refractive index oxide layer and a low refractive index oxide layer alternatively laminated on a transparent substrate. The number of the high refractive index oxide layer and the low refractive index oxide layer laminated is not necessarily limited, and from the viewpoint of productivity, the total number of the high refractive index oxide layer and the low refractive index oxide layer is generally set to about four (see, for example, Patent Literature 1).

In the anti-reflective laminate, in order to improve the appearance of an image display device or the like equipped with the anti-reflective laminate, it is required that a reflection color be a moderate chromatic color and that a change in reflection color due to a change in incident angle of light, i.e., so-called polychromaticity, is reduced. That is, it is required that the reflection color when viewed from the front be a moderate chromatic color that is not excessively blue, and that the reflection color when viewed from an oblique angle be a white color that is not excessively red.

As an anti-reflective laminate having a reflection color with a moderate chromatic color and having prevented polychromaticity, for example, there is known an anti-reflective laminate provided with a first oxide layer, a second oxide layer, and a third oxide layer on a substrate, in which the first oxide layer has a refractive index of 1.74 to 1.88 and a thickness of 45 nm to 65 nm, the second oxide layer has a refractive index of 1.9 to 2.1 and a thickness of 90 nm to 110 nm, and the third oxide layer has a refractive index of 1.48 or less and a thickness of 80 nm to 110 nm (see, for example, Patent Literature 2).

### CITATION LIST

### Patent Literature

Patent Literature 1: JP2003-215309A
Patent Literature 2: JP2006-289901A

### SUMMARY OF INVENTION

In the anti-reflective laminate in which the high refractive index oxide layer and the low refractive index oxide layer are alternatively laminated, due to a slight difference in production conditions, the oxide layer may not necessarily have a desired thickness, which may result in the reflection color not being a moderate chromatic color and in a large change in reflection color depending on the angle. Therefore, in order to ensure a stable quality during actual product production, it is required the change in reflection color can be reduced even when the thickness fluctuates.

Further, a cover glass for use in vehicle interior instrument panels, dashboards, or the like is often a large glass having a curved surface, and in an anti-reflective laminate for use in such a large curved glass, since a change in reflection color due to a difference in angle caused by the curved surface is particularly large, there is a problem that the color changes depending on the location and strong redness is generated, which deteriorates the designability.

Therefore, an object of the present invention is to provide an anti-reflective laminate having a reduced angle-dependent change in reflection color and having high designability.

As a result of extensive investigation, the inventors of the present invention have found that, in an anti-reflective laminate including a substrate and an anti-reflective layer having four refractive index layers, when a refractive index and a thickness of each of the four refractive index layers are adjusted to fall within specific ranges, an anti-reflective laminate having a reduced angle-dependent change in reflection color and having high designability can be provided. Thus, the present invention has been completed.

That is, one embodiment of the present invention relates to an anti-reflective laminate including: a substrate; and an anti-reflective layer laminated on the substrate and having a four-layer structure including a first refractive index layer, a second refractive index layer, a third refractive index layer, and a fourth refractive index layer in order from a substrate side, in which the first refractive index layer has a refractive index of 1.25 to 1.50, the second refractive index layer has a refractive index of 1.50 to 2.40, the third refractive index layer has a refractive index of 2.25 to 2.45, and the fourth refractive index layer has a refractive index of 1.25 to 1.50, and the first refractive index layer has a thickness of 40 nm to 105 nm, the second refractive index layer has a thickness of 60 nm to 90 nm, the third refractive index layer has a thickness of 80 nm to 110 nm, and the fourth refractive index layer has a thickness of 70 nm to 100 nm.

According to the one embodiment of the present invention, an anti-reflective laminate having a reduced angle-dependent change in reflection color and having high designability can be provided.

### BRIEF DESCRIPTION OF DRAWINGS

FIG. 1 is a cross-sectional view schematically showing a configuration example of an anti-reflective laminate according to an embodiment of the present invention.

FIG. 2 is a coordinate diagram showing a distance 1 (a₁*²+b₁*²)^{1/2} from a chromaticity coordinate origin to chromaticity coordinates (a₁*, b₁*) of reflected light at an incident angle of 30°, and a distance 2 (a₂*²+b₂*²)^{1/2} from the chromaticity coordinate origin to chromaticity coordinates (a₂*, b₂*) of reflected light at an incident angle of 7°.

### DESCRIPTION OF EMBODIMENTS

Hereinafter, the present invention is described in detail, but the present invention is not limited to the following embodiment and can be freely modified and implemented without departing from the gist of the present invention. In addition, “to” indicating a numerical range is used to include numerical values written before and after it as a lower limit value and an upper limit value.

### <<Anti-Reflective Laminate>>

First, a configuration of an anti-reflective laminate according to an embodiment of the present invention (hereinafter, also referred to as the anti-reflective laminate according to the present embodiment) is described.

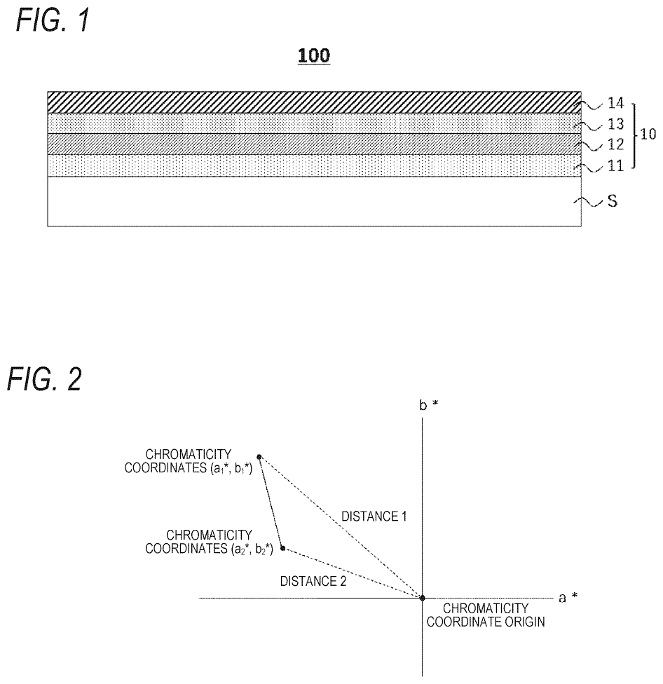

FIG. 1 is a cross-sectional view schematically showing a configuration example of the anti-reflective laminate according to the present embodiment.

An anti-reflective laminate 100 is formed by laminating, on a substrate S, an anti-reflective layer 10 having a four-layer structure including a first refractive index layer 11, a second refractive index layer 12, a third refractive index layer 13, and a fourth refractive index layer 14 in order from a substrate S side.

Note that, in the anti-reflective laminate 100 in FIG. 1, the first refractive index layer 11 is provided on the substrate S. However, in the anti-reflective laminate according to the present embodiment, an adhesion layer, an anti-glare layer, a hard coat layer, or the like may be provided between the substrate and the anti-reflective layer, as to be described later.

### [Substrate]

The substrate may be any known substrate such as a glass or a resin film.

The substrate preferably has a refractive index of 1.4 or more and 1.7 or less. When the refractive index of the substrate is within the above range, reflection at an adhesion surface can be sufficiently prevented in the case of optically adhering a display, a touch panel, or the like. The refractive index of the substrate is more preferably 1.45 or more, still more preferably 1.47 or more, and is more preferably 1.65 or less, still more preferably 1.6 or less.

The substrate preferably includes at least one of a glass and a resin.

In the case where the substrate includes a glass, the kind of the glass is not particularly limited, and glasses having various compositions can be used. Among them, the glass preferably contains quartz or sodium and preferably has a composition that allows molding and strengthening by a chemical strengthening treatment. Specific examples thereof include a quartz glass, an aluminosilicate glass, a soda lime glass, a borosilicate glass, an alkali-free glass, a lead glass, an alkali barium glass, and an aluminoborosilicate glass. Note that, in the present description, in the case where the substrate includes a glass, the substrate is also called a glass substrate.

The thickness of the glass substrate is not particularly limited, and is generally preferably 5 mm or less, more preferably 3 mm or less, and still more preferably 1.5 mm or less. It is generally 0.2 mm or more.

The glass substrate is preferably a chemically strengthened glass obtained by chemical strengthening. Accordingly, the strength of the anti-reflective laminate is increased. Note that, in the case where an anti-glare layer or the like to be described later is provided on the glass substrate, the chemical strengthening is performed after the anti-glare layer or the like is provided and before an anti-reflective layer to be described later is formed.

In the case where the substrate includes a resin, the kind of the resin is not particularly limited, and resins having various compositions can be used. Among them, the resin is preferably a thermoplastic resin or a thermosetting resin. Examples thereof include a polyvinyl chloride resin, a polyethylene resin, a polypropylene resin, a polystyrene resin, a polyvinyl acetate resin, a polyester resin, a polyurethane resin, a cellulose-based resin, an acrylic resin, an AS (acrylonitrile-styrene) resin, an ABS (acrylonitrile-butadiene-styrene) resin, a fluorine-based resin, a thermoplastic elastomer, a polyamide resin, a polyimide resin, a polyacetal resin, a polycarbonate resin, a modified polyphenylene ether resin, a polyethylene terephthalate resin, a polybutylene terephthalate resin, a polylactic acid-based resin, a cyclic polyolefin resin, and a polyphenylene sulfide resin. Among them, a cellulose-based resin is preferred, and examples thereof include a triacetyl cellulose resin, a polycarbonate resin, and a polyethylene terephthalate resin. These resins may be used alone or in combination of two or more kinds thereof. The resin particularly preferably contains at least one resin selected from polyethylene terephthalate, a polycarbonate, acrylic, silicone, and triacetyl cellulose.

Note that, in the present description, in the case where the substrate includes a resin, the substrate is also called a resin substrate.

The shape of the resin substrate is not particularly limited. Examples thereof include a film shape or a plate shape, and a film shape is preferred from the viewpoint of shatterproofness. In the case where the resin substrate has a film shape, that is, when it is a resin film, the thickness is not particularly limited, and is preferably 20 μm to 250 μm, and more preferably 40 μm to 188 μm. In the case where the resin substrate has a plate shape, that is, when it is a resin plate, the thickness is not particularly limited, and is preferably generally 5 mm or less, more preferably 3 mm or less, and still more preferably 1.5 mm or less. It is generally 0.2 mm or more.

In the case where the substrate includes both a glass and a resin, for example, the resin substrate may be provided on the glass substrate.

### [Anti-Reflective Layer]

As shown in FIG. 1, the anti-reflective laminate 100 according to the present embodiment has, on the substrate S, an anti-reflective layer having a four-layer structure including the first refractive index layer 11, the second refractive index layer 12, the third refractive index layer 13, and the fourth refractive index layer 14 in order from the substrate S side.

### (First and Fourth Refractive Index Layers)

The first refractive index layer and the fourth refractive index layer each have a refractive index of 1.25 to 1.50. When the refractive index of the first refractive index layer and the fourth refractive index layer is within the above range, the redness of the reflection color can be reduced, a change in reflection color due to a change in incident angle can be reduced, and polychromaticity can be effectively prevented. The refractive index of the first refractive index layer and the fourth refractive index layer is preferably 1.26 or more, more preferably 1.27 or more, still more preferably 1.28 or more, and is preferably 1.49 or less, more preferably 1.48 or less, still more preferably 1.47 or less.

The refractive index of the first refractive index layer and the fourth refractive index layer can be determined by the method described in Examples to be described later.

The first refractive index layer has a thickness of 40 nm to 105 nm. When the thickness of the first refractive index layer is within the above range, the redness of the reflection color can be reduced, the change in reflection color due to the change in incident angle can be reduced, and the polychromaticity can be effectively prevented. The thickness of the first refractive index layer is preferably 42 nm or more, more preferably 44 nm or more, still more preferably 46 nm or more, and is preferably 103 nm or less, more preferably 101 nm or less, still more preferably 99 nm or less.

The thickness of the first refractive index layer can be determined by measuring a reflectance at each wavelength using a spectrophotometer (trade name: SolidSpec3700 manufactured by Shimadzu Corporation) and using TF-Calc (manufactured by HULINKS Inc.) with a refractive index dispersion and the thickness as variables from the actual reflection spectrum obtained. The thicknesses of the second to fourth refractive index layers to be described later can be determined in a similar manner.

In addition, the first refractive index layer has a greater influence on the polychromaticity than the second refractive index layer to the fourth refractive index layer. For example, when the first refractive index layer is thin, the change in reflection color is likely to be sensitive to the change in incident angle. From this viewpoint, the thickness of the first refractive index layer is preferably 40 nm or more, more preferably 42 nm or more, still more preferably 44 nm or more, and particularly preferably 46 nm or more.

The fourth refractive index layer has a thickness of 70 nm to 100 nm. When the thickness of the fourth refractive index layer is within the above range, the redness of the reflection color can be reduced, the change in reflection color due to the change in incident angle can be reduced, and the polychromaticity can be effectively prevented. The thickness of the fourth refractive index layer is preferably 72 nm or more, more preferably 74 nm or more, still more preferably 76 nm or more, and is preferably 98 nm or less, more preferably 96 nm or less, still more preferably 94 nm or less.

The constituent materials of the first refractive index layer and the fourth refractive index layer are not particularly limited as long as they are selected such that the refractive index of the first refractive index layer and the fourth refractive index layer are within the range of 1.25 to 1.50. Low refractive index materials such as a silicon oxide such as silica (SiO₂) and magnesium fluoride may be used as the constituent material. The first refractive index layer and the fourth refractive index layer may be made of only one kind or may be made of two or more kinds selected from metal oxides. In the case where the layers are made of two or more kinds, a composite oxide of two metals may be further included.

The first refractive index layer and the fourth refractive index layer can be formed using a known film-forming method.

Examples of the above known film-forming method include a dry film-forming process such as a CVD method, a sputtering method, or a vacuum deposition method, and a wet film-forming process such as a spraying method or a dipping method. A dry film-forming process is preferred from the viewpoint of easily obtaining a film having an appropriately controlled thickness and quality.

Among the dry film-forming process, a sputtering method is more preferred from the viewpoint of easily obtaining a film having an appropriately controlled thickness and quality. Examples of the sputtering method include methods such as magnetron sputtering, pulse sputtering, AC sputtering, and digital sputtering.

The magnetron sputtering method is a method in which a magnet is placed on a back surface of a base dielectric material to generate a magnetic field, and gas ion atoms collide with the surface of the dielectric material and are ejected, to form a sputtering film having a thickness of several nm, and a film of a dielectric that is an oxide or a nitride of the dielectric material can be formed.

The digital sputtering method is a method of forming a metal oxide thin film by repeating steps of first forming a metal ultra-thin film by sputtering, and then oxidizing the film by irradiation with oxygen plasma, oxygen ions, or oxygen radicals in the same chamber. In this case, since film-forming molecules are metals when deposited on a substrate, it is presumed to be more ductile than a case of depositing a metal oxide. Therefore, it is conceivable that even when the energy is the same, rearrangement of the film-forming molecules is likely to occur, and as a result, a dense and smooth film can be formed.

In addition, the first refractive index layer and the fourth refractive index layer may be formed a wet method from the viewpoint of being able to easily set the refractive index within a low refractive index range of 1.25 to 1.50 and being able to easily impart other properties such as antifouling property, water resistance, and chemical resistance.

### (Second Refractive Index Layer)

The second refractive index layer has a refractive index of 1.50 to 2.40. When the refractive index of the second refractive index layer is within the above range, the redness of the reflection color can be reduced, the change in reflection color due to the change in incident angle can be reduced, and the polychromaticity can be effectively prevented. The refractive index of the second refractive index layer is preferably 1.61 or more, more preferably 1.62 or more, still more preferably 1.63 or more, and is preferably 1.79 or less, more preferably 1.78 or less, still more preferably 1.77 or less.

The refractive index of the second refractive index layer can be determined by the method described in Examples to be described later.

The second refractive index layer has a thickness of 60 nm to 90 nm. When the thickness of the second refractive index layer is within the above range, the redness of the reflection color can be reduced, the change in reflection color due to the change in incident angle can be reduced, and the polychromaticity can be effectively prevented. The thickness of the second refractive index layer is preferably 62 nm or more, more preferably 64 nm or more, still more preferably 66 nm or more, and is preferably 88 nm or less, more preferably 86 nm or less, still more preferably 84 nm or less.

The constituent material of the second refractive index layer is not particularly limited as long as it is selected such that the refractive index of the second refractive index layer is within the range of 1.50 to 2.40. Examples thereof include a silicon oxide such as silica (SiO₂), indium oxide, tin oxide, niobium oxide, a titanium oxide such as titania (TiO₂), zirconium oxide, cerium oxide, tantalum oxide, aluminum oxide, zinc oxide, and other metal oxides. The second refractive index layer may be made of only one kind selected from these metal oxides. It is preferable to use two or more kinds since it is easy to achieve a medium refractive index within the range of 1.50 to 2.40. In the case where the layer is made of two or more kinds, a composite oxide of two metals may be further included. In particular, in the present embodiment, the second refractive index layer preferably contains a silicon oxide and a titanium oxide. When a titanium oxide, which has a high refractive index, and a silicon oxide, which has a low refractive index, are mixed among dielectric materials, the range of refractive index adjustment can be expanded. The ratio (silicon oxide/titanium oxide) of the silicon oxide to the titanium oxide in the second refractive index layer is preferably 0.1 to 0.9, and more preferably 0.15 to 0.85, on a mass basis.

The second refractive index layer can be formed by a dry method or a wet method, like the first refractive index layer and the fourth refractive index layer described above. As the dry method, for example, a chemical vapor deposition (CVD) method or a physical vapor deposition (PVD) method, particularly a vacuum deposition method or a sputtering method, which are types of physical vapor deposition methods, can be suitably used.

### (Third Refractive Index Layer)

The third refractive index layer has a refractive index of 2.25 to 2.45. When the refractive index of the third refractive index layer is within the above range, the redness of the reflection color can be reduced, the change in reflection color due to the change in incident angle can be reduced, and the polychromaticity can be effectively prevented. The refractive index of the third refractive index layer is preferably 2.26 or more, more preferably 2.27 or more, still more preferably 2.28 or more, and is preferably 2.44 or less, more preferably 2.43 or less, still more preferably 2.42 or less.

The refractive index of the third refractive index layer can be determined by the method described in Examples to be described later.

The third refractive index layer has a thickness of 80 nm to 110 nm. When the thickness of the third refractive index layer is within the above range, the redness of the reflection color can be reduced, the change in reflection color due to the change in incident angle can be reduced, and the polychromaticity can be effectively prevented. The thickness of the third refractive index layer is preferably 82 nm or more, more preferably 84 nm or more, still more preferably 86 nm or more, and is preferably 108 nm or less, more preferably 106 nm or less, still more preferably 104 nm or less.

The constituent material of the third refractive index layer is not particularly limited as long as it is selected such that the refractive index of the third refractive index layer is within the range of 2.25 to 2.45. Examples of materials that can provide a relatively high refractive index include metal oxides such as niobium oxide and a titanium oxide such as titania (TiO₂). The third refractive index layer may be made of only one kind selected from these, or may be made of two or more kinds selected from the group consisting of these metal oxides and a silicon oxide. In the case where the layer is made of two or more kinds, a composite oxide of two metals may be further included.

The third refractive index layer can be formed by a dry method or a wet method, like the first refractive index layer and the fourth refractive index layer described above. As the dry method, for example, a chemical vapor deposition (CVD) method or a physical vapor deposition (PVD) method, particularly a vacuum deposition method or a sputtering method, which are types of physical vapor deposition methods, can be suitably used.

### [Adhesion Layer]

In the anti-reflective laminate according to the present embodiment, an adhesion layer can be provided between the substrate and the anti-reflective layer. When the anti-reflective laminate according to the present embodiment is provided with an adhesion layer, the adhesion between the substrate and the anti-reflective layer can be improved, and the influence of degassing from the substrate can be prevented.

The kind of the adhesion layer is not particularly limited, and may be an organic layer made of a resin or the like, or an inorganic layer. Hereinafter, each case is described in detail.

### (Organic Layer)

The organic layer is preferably a resin layer containing a predetermined resin. The kind of the resin forming the resin layer is not particularly limited, and examples thereof include a silicone resin, a polyimide resin, an acrylic resin, a polyolefin resin, a polyurethane resin, and a fluorine-based resin. Several kinds of resins may also be mixed and used. Among them, a silicone resin, a polyimide resin, and a fluorine-based resin are preferred.

The thickness of the organic layer is not particularly limited, and is preferably 1 μm to 100 μm, more preferably 5 μm to 30 μm, and still more preferably from 7 μm to 20 μm. When the thickness of the organic layer is within the above range, the adhesion between the substrate and the anti-reflective layer is sufficient.

In addition, in order to improve the flatness of the organic layer, the organic layer may contain a leveling agent. The kind of the leveling agent is not particularly limited, and a representative example is a fluorine-based leveling agent.

### (Inorganic Layer)

The material constituting the inorganic layer is not particularly limited, and preferably contains, for example, at least one selected from the group consisting of an oxide, a nitride, an oxynitrides, a carbide, a carbonitride, a silicide, and a fluoride.

Examples of the oxide (preferably a metal oxide), the nitride (preferably a metal nitride), and the oxynitride (preferably a metal oxynitride) include an oxide, a nitride, and an oxynitride of one or more elements selected from Si, Hf, Zr, Ta, Ti, Y, Nb, Na, Co, Al, Zn, Pb, Mg, Bi, La, Ce, Pr, Sm, Eu, Gd, Dy, Er, Sr, Sn, In, and Ba. More specific examples thereof include a silicon oxynitride (SiNₓO_{y}), titanium oxide (TiO₂), indium oxide (In₂O₃), indium cerium oxide (ICO), tin oxide (SnO₂), zinc oxide (ZnO), gallium oxide (Ga₂O₃), indium tin oxide (ITO), indium zinc oxide (IZO), zinc tin oxide (ZTO), and gallium doped zinc oxide (GZO).

Examples of the carbide (preferably a metal carbide) and the carbonitride (preferably a metal carbonitride) include a carbide, a carbonitride, and a carbonate of one or more elements selected from Ti, W, Si, Zr, and Nb. For example, silicon oxycarbide (SiCO) can be used.

Note that, the carbide may be a so-called carbon material, for example, a carbide obtained by sintering a resin component such as a phenol resin.

Examples of the silicide (preferably a metal silicide) include a silicide of one or more elements selected from Mo, W, and Cr.

Examples of the fluoride (preferably a metal fluoride) include a fluoride of one or more elements selected from Mg, Y, La, and Ba. For example, magnesium fluoride (MgF₂) can be used.

The thickness of the inorganic layer is not particularly limited, and from the viewpoint of the adhesion between the substrate and the anti-reflective layer, the thickness is preferably 5 nm to 5000 nm, and more preferably 10 nm to 500 nm.

A surface roughness (Ra) of the inorganic layer on the surface in contact with the anti-reflective layer is preferably 2.0 nm or less, and more preferably 1.0 nm or less. The lower limit value is not particularly limited, and most preferably 0. Within the above range, the adhesion with the anti-reflective layer is improved.

The Ra is measured according to JIS B 0601 (revised in 2001).

The adhesion layer may be a plasma-polymerized film. When the adhesion layer is a plasma-polymerized film, examples of a material forming the plasma-polymerized film include fluorocarbon monomers such as CF₄, CHF₃, and CH₃F, hydrocarbon monomers such as methane, ethane, propane, ethylene, propylene, acetylene, benzene, toluene, and C₄H₈, hydrogen, and SF₆. In particular, a plasma-polymerized film made of a fluorocarbon monomer or a hydrocarbon monomer is preferred. These may be used alone or in combination of two or more kinds thereof.

From the viewpoint of scratch resistance, the thickness of the plasma-polymerized film is preferably 1 nm to 100 nm, more preferably 1 nm to 50 nm, and still more preferably 1 nm to 10 nm.

### (Anti-Glare Layer and Hard Coat Layer)

In the present embodiment, at least one of an anti-glare layer and a hard coat layer may be provided on the surface of the substrate on which the anti-reflective layer is provided.

The anti-glare layer has irregularities on one surface thereof, and thereby causes external scattering or internal scattering, increasing the haze value and imparting anti-glare properties. The anti-glare layer can be those known in the related art, and may be formed of, for example, an anti-glare layer composition obtained by dispersing a particulate substance at least having anti-glare properties per se in a solution in which a polymer resin is dissolved as a binder. The anti-glare layer can be formed, for example, by coating one main surface of the substrate with the anti-glare layer composition.

Examples of the particulate substance having anti-glare properties include inorganic fine particles such as silica, clay, talc, calcium carbonate, calcium sulfate, barium sulfate, aluminum silicate, titanium oxide, synthetic zeolite, alumina, and smectite, and organic fine particles including a styrene resin, a urethane resin, a benzoguanamine resin, a silicone resin, an acrylic resin, or the like.

The hard coat layer can be those known in the related art, and may be formed of, for example, a hard coat layer composition containing a polymer resin to be described later. The hard coat layer can be formed by, for example, coating one main surface of a substrate such as a transparent substrate with the hard coat layer composition.

In addition, as the polymer resin as a binder for the anti-glare layer or the hard coat layer, for example, polymer resins such as a polyester-based resin, an acrylic resin, an acrylic urethane-based resin, a polyester acrylate-based resin, a polyurethane-based acrylate resin, an epoxy acrylate-based resin, and a urethane-based resin can be used.

### (Antifouling Film)

The anti-reflective laminate according to the present embodiment may further include an antifouling film (also referred to as an “anti finger print (AFP) film”) on the anti-reflective layer, from the viewpoint of protecting the outermost surface thereof. The antifouling film can be formed of, for example, a fluorine-containing organosilicon compound. The fluorine-containing organosilicon compound is not particularly limited as long as it can impart an antifouling property, water repellency, and oil repellency, and examples thereof include a fluorine-containing organosilicon compound having one or more groups selected from the group consisting of a polyfluoropolyether group, a polyfluoroalkylene group, and a polyfluoroalkyl group. Note that, the polyfluoropolyether group is a divalent group having a structure in which polyfluoroalkylene groups and etheric oxygen atoms are alternately bonded.

As a commercially available fluorine-containing organosilicon compound having one or more groups selected from the group consisting of a polyfluoropolyether group, a polyfluoroalkylene group, and a polyfluoroalkyl group, KP-801 (trade name, manufactured by Shin-Etsu Chemical Co., Ltd.), KY178 (trade name, manufactured by Shin-Etsu Chemical Co., Ltd.), KY-130 (trade name, manufactured by Shin-Etsu Chemical Co., Ltd.), KY-185 (trade name, manufactured by Shin-Etsu Chemical Co., Ltd.), and Optool (registered trademark) DSX and Optool AES (trade name, all manufactured by Daikin Industries, Ltd.) can be preferably used.

### (Adhesive Layer)

The anti-reflective laminate according to the present embodiment may include an adhesive layer on one of two main surfaces of the substrate, that is, the main surface on which the anti-reflective layer is not provided. The anti-reflective laminate is attached to, for example, an image display device via the adhesive layer. The adhesive layer can be formed by using a known adhesive composition, and examples thereof include an optical clear adhesive (OCA) and an optical clear resin (OCR) such as a UV curable resin. Examples of the OCA and the OCR include polymers such as an acrylic polymer, a silicone-based polymer, a polyester, a polyurethane, a polyamide, a polyvinyl ether, a vinyl acetate/vinyl chloride copolymer, a modified polyolefin, and rubbers such as an epoxy-based rubber, fluorine-based rubber, a natural rubber, or a synthetic rubber. Particularly, an acrylic polymer is suitably used since it exhibits adhesive properties such as moderate wettability, cohesiveness, and adhesion, is also excellent in transparency, weather resistance, heat resistance, and solvent resistance, and has a wide range of adhesive strength.

The adhesive layer has a luminous transmittance of preferably 90% or more, more preferably 91% or more, and still more preferably 92% or more, as measured using a spectrophotometer according to the provisions in JIS Z 8709 (1999). When the transmittance of the adhesive layer is within the above range, the visibility of, for example, an image display device is not impaired.

### (Chromaticity Coordinate a* of Reflected Light)

The anti-reflective laminate according to the present embodiment preferably has a chromaticity coordinate a* of reflected light at each of an incident angle of 7° and an incident angle of 30° of 2.0 or less. The incident angle of 7° and the incident angle of 30° correspond to, for example, an angle at which a display for use in an in-vehicle navigation system is viewed from the front toward a driver's seat, and an angle at which a display showing an in-vehicle speedometer or the like is viewed downward from the driver's seat. Therefore, “the chromaticity coordinate a* of the reflected light at an incident angle of 7° and an incident angle of 30° being 2.0 or less” means that, for example, there is a small change in redness of the reflection color due to a change in incident angle on a vehicle display or the like. In the anti-reflective laminate according to the present embodiment, when the anti-reflective layer has a four-layer structure including a first refractive index layer to a fourth refractive index layer, and the refractive index and the thickness of each refractive index layer are within predetermined ranges, the chromaticity coordinate a″ of the reflected light at an incident angle of 7° and an incident angle of 30° can be made 2.0 or less.

The chromaticity coordinate a* of the reflected light at an incident angle of 7° and an incident angle of 30° is more preferably 1.9 or less, still more preferably 1.8 or less, and particularly preferably 1.7 or less.

The chromaticity coordinate a of the reflected light at an incident angle of 7° and an incident angle of 30° can be measured using a spectrocolorimeter (for example, trade name: CM-26d manufactured by Konica Minolta, Inc.) according to the method specified in JIS Z 8722 (2009). Note that, during the measurement, a black tape (for example, “KUKKIRI MIERU” manufactured by TOMOEGAWA CORPORATION, diffusion reflectance is equivalent to approximately 0.01% in SCE Y under a D65 light source) is attached to a back surface side (substrate side) of the anti-reflective laminate to eliminate reflection on the other main surface.

### (Color Difference ΔE of Reflected Lights)

The anti-reflective laminate according to the present embodiment preferably has a color difference ΔE between reflected lights at an incident angle of 7° and an incident angle of 30° of 4.0 or less. The “color difference ΔE between the reflected lights at an incident angle of 7° and an incident angle of 30° being 4.0 or less” means a small change in object color due to a change in incident angle. In the anti-reflective laminate according to the present embodiment, when the anti-reflective layer has a four-layer structure including a first refractive index layer to a fourth refractive index layer, and the refractive index and the thickness of each refractive index layer are within predetermined ranges, the color difference ΔE between the reflected lights at an incident angle of 7° and an incident angle of 30° can be made 4.0 or less.

In the anti-reflective laminate according to the present embodiment, the color difference ΔE between the reflected lights at an incident angle of 7° and an incident angle of 30° is more preferably 3.9 or less, still more preferably 3.8 or less, and particularly preferably 3.7 or less.

The color difference ΔE between the reflected lights at an incident angle of 7° and an incident angle of 30° in the anti-reflective laminate according to the present embodiment is calculated according to the following equation.

Color difference ΔE=[(L₁*−L₂*)²+(a₁*−a₂*)₂+(b₁*−b₂*)²]^{1/2} Equation(1)

In the above equation (1), L₁*, a₁*, and b₁* respectively mean the chromaticities L*, a*, and b* of the reflected light at an incident angle of 30°. In the above equation (1), L₂*, a₂*, and b₂* respectively mean the chromaticities L*, a*, and b* of the reflected light at an incident angle of 7°.

The chromaticities L*, a*, and b* of the reflected light at an incident angle of 7° and an incident angle of 30° in the anti-reflective laminate according to the present embodiment can be measured using a spectrocolorimeter (trade name: CM-26d manufactured by Konica Minolta, Inc.) according to the method specified in JIS Z 8722 (2009). Note that, during the measurement, a black tape (for example, “KUKKIRI MIERU” manufactured by TOMOEGAWA CORPORATION, diffusion reflectance is equivalent to approximately 0.01% in SCE Y under a D65 light source) is attached to a back surface side (substrate side) of the anti-reflective laminate to eliminate reflection on the other main surface.

(Distance from Chromaticity Coordinate Origin to Chromaticity Coordinate (a*, b*) of Reflected Light)

In the anti-reflective laminate according to the present embodiment, a maximum value of distances (a*²+b*²)^{1/2} from a chromaticity coordinate origin to chromaticity coordinates (a*, b*) of reflected lights at an incident angle of 7° and an incident angle of 30° is preferably 6.5 or less. The “maximum value of the distances (a*²+b*²)^{1/2} from the chromaticity coordinate origin to the chromaticity coordinates (a*, b*) of the reflected lights at an incident angle of 7° and an incident angle of 30° being 6.5 or less” means that, as shown in FIG. 2, a larger distance (maximum value) between a distance 1 (a₁*²+b₁*²)^{1/2} from the chromaticity coordinate origin to chromaticity coordinates (a₁*, b₁*) of the reflected light at an incident angle of 30° and a distance 2(a₂*²+b₂*²)^{1/2} from the chromaticity coordinate origin to chromaticity coordinates (a₂*, b₂*) of the reflected light at an incident angle of 7° is 6.5 or less. In FIG. 2, since the distance 1 is longer than the distance 2, the maximum value being 6.5 or less means that the distance 1 (a₁*²+b₁*²)^{1/2} is 6.5 or less.

The “maximum value of the distances from the chromaticity coordinate origin to the chromaticity coordinates of the reflected lights at an incident angle of 7° and an incident angle of 30° being 6.5 or less” means a small change in reflection color due to the change in incident angle, and a smaller change from colorless. In the anti-reflective laminate according to the present embodiment, when the anti-reflective layer has a four-layer structure including a first refractive index layer to a fourth refractive index layer, and the refractive index and the thickness of each refractive index layer are within predetermined ranges, the maximum value of the distances from the chromaticity coordinate origin to the chromaticity coordinates of the reflected lights at incident angles of 7° and 30° can be made 6.5 or less.

In the anti-reflective laminate according to the present embodiment, the maximum value of the distances from the chromaticity coordinate origin to the chromaticity coordinates of the reflected lights at an incident angle of 7° and an incident angle of 30° is more preferably 6.3 or less, and still more preferably 6.1 or less.

The chromaticity coordinates a*, b* of the reflected light at an incident angle of 7° and an incident angle of 30° in the anti-reflective laminate according to the present embodiment can be measured using a spectrocolorimeter (trade name: CM-26d manufactured by Konica Minolta, Inc.) according to the method specified in JIS Z 8722 (2009). Note that, during the measurement, a black tape (for example, “KUKKIRI MIERU” manufactured by TOMOEGAWA CORPORATION, diffusion reflectance is equivalent to approximately 0.01% in SCE Y under a D65 light source) is attached to a back surface side (substrate side) of the anti-reflective laminate to eliminate reflection on the other main surface.

In the anti-reflective laminate according to the present embodiment, when the anti-reflective layer has a four-layer structure including a first refractive index layer to a fourth refractive index layer, and the refractive index and the thickness of each refractive index layer are within predetermined ranges, particularly, the chromaticity coordinate a of the reflected light at an incident angle of 7° and an incident angle of 30° can be made 2.0 or less, and the color difference ΔE between the reflected light at an incident angle of 7° and the reflected light at an incident angle of 30° can be made 4.0 or less.

In addition, in the anti-reflective laminate according to the present embodiment, when the anti-reflective layer has a four-layer structure including a first refractive index layer to a fourth refractive index layer, and the refractive index and the thickness of each refractive index layer are within predetermined ranges, the chromaticity coordinate a* of the reflected light at an incident angle of 7° and an incident angle of 30° can be made 2.0 or less, and the maximum value of the distances (a*²+b*²)^{1/2} from the chromaticity coordinate origin to the chromaticity coordinates (a*, b*) of the reflected lights at an incident angle of 7° and an incident angle of 30° can be made 6.5 or less.

### (Luminous Reflectance: SCI Y)

The anti-reflective laminate according to the present embodiment preferably has a luminous reflectance (SCI Y) of 0.9% or less. When the luminous reflectance (SCI Y) is within the above range, in the case where the anti-reflective laminate is used in an image display device, an effect of preventing glare of external light on a screen is high. In the anti-reflective laminate according to the present embodiment, when the anti-reflective layer has a four-layer structure including a first refractive index layer to a fourth refractive index layer, and the refractive index and the thickness of each refractive index layer are within predetermined ranges, the redness of the reflection color can be reduced, and the luminous reflectance can be made 0.9% or less while preventing the polychromaticity.

The luminous reflectance (SCI Y) is more preferably 0.8% or less, still more preferably 0.7% or less, and particularly preferably 0.6% or less.

Note that, the luminous reflectance (SCI Y) is a reflection stimulus value Y specified in JIS Z 8701 (1999), and is determined by measuring a spectral reflectance using a spectrophotometer (for example, trade name: SolidSpec-3700 manufactured by Shimadzu Corporation) and performing calculation. Note that, during the measurement, a black tape (“KUKKIRI MIERU” manufactured by TOMOEGAWA CORPORATION, diffusion reflectance is equivalent to approximately 0.01% in SCE Y under a D65 light source) is attached to a back surface side (substrate side) of the anti-reflective laminate to eliminate reflection on the other main surface.

The anti-reflective laminate according to the present embodiment can be applied to image display devices such as a liquid crystal display (LCD), a plasma display panel (PDP), an electroluminescence display (ELD), a cathode ray tube display (CRT), and a surface-effect-field display (SED).

The anti-reflective laminate according to the present embodiment is used, for example, by adhering the substrate side to the image display surface of an image display device. When the anti-reflective laminate according to the present embodiment is applied to an image display device or the like, the appearance of the image display device or the like can be improved.

### <<Method for Producing Anti-Reflective Laminate>>

Next, a method for producing an anti-reflective laminate according to an embodiment of the present invention is described. The method for producing an anti-reflective laminate according to the present embodiment includes, forming on a substrate, an anti-reflective layer having a four-layer structure including a first refractive index layer, a second refractive index layer, a third refractive index layer, and a fourth refractive index layer in this order from a substrate side. In addition, an adhesion layer, an anti-glare layer, a hard coat layer, or the like may be formed between the substrate and the anti-reflective layer using any known method.

As described above, each of the refractive index layers can be laminated using a known film-forming method such as a dry film-forming process such as a CVD method, a sputtering method, or a vacuum deposition method, and a wet film-forming process such as a spraying method or a dipping method. From the viewpoint of easily obtaining a high refractive index film layer with a controlled thin film layer, a dry film-forming process is preferred, and among them, a sputtering method is more preferred.

Examples of the sputtering method include methods such as magnetron sputtering, pulse sputtering, AC sputtering, and digital sputtering.

For example, the magnetron sputtering is a method in which a magnet is placed on a back surface of a base dielectric material to generate a magnetic field, and gas ion atoms collide with the surface of the dielectric material and are ejected, to form a sputtering film having a thickness of several nm, and a continuous film of an anti-reflective layer (refractive index layer), which is an oxide or a nitride of the dielectric material, can be formed.

In addition, the digital sputtering is a method of forming a metal oxide thin film by repeating steps of first forming a metal ultra-thin film by sputtering, and then oxidizing the film by irradiation with oxygen plasma, oxygen ions, or oxygen radicals in the same chamber. In this case, since film-forming molecules are metals when deposited on a substrate, it is presumed to be more ductile than a case of depositing a metal oxide. Therefore, it is conceivable that even when the energy is the same, rearrangement of the film-forming molecules is likely to occur, and as a result, a dense and smooth film can be formed.

As described above, the following matters are disclosed in the present description.

(1) An anti-reflective laminate including:
a substrate; and
an anti-reflective layer laminated on the substrate and having a four-layer structure including a first refractive index layer, a second refractive index layer, a third refractive index layer, and a fourth refractive index layer in order from a substrate side, in which
the first refractive index layer has a refractive index of 1.25 to 1.50, the second refractive index layer has a refractive index of 1.50 to 2.40, the third refractive index layer has a refractive index of 2.25 to 2.45, and the fourth refractive index layer has a refractive index of 1.25 to 1.50, and
the first refractive index layer has a thickness of 40 nm to 105 nm, the second refractive index layer has a thickness of 60 nm to 90 nm, the third refractive index layer has a thickness of 80 nm to 110 nm, and the fourth refractive index layer has a thickness of 70 nm to 100 nm.

(2) The anti-reflective laminate according to the above (1), in which the second refractive index layer includes a silicon oxide and a titanium oxide.

(3) The anti-reflective laminate according to the above (1) or (2), in which a chromaticity coordinate a″ of reflected light at an incident angle of 7° and an incident angle of 30° is 2.0 or less, and a color difference ΔE between reflected lights at an incident angle of 7° and an incident angle of 30° is 4.0 or less.

(4) The anti-reflective laminate according to any one of the above (1) to (3), in which a chromaticity coordinate a* of reflected light at an incident angle of 7° and an incident angle of 30° is 2.0 or less, and a maximum value of distances (a*²++b*²)^{1/2} from a chromaticity coordinate origin to chromaticity coordinates (a*, b*) of reflected lights at an incident angle of 7° and an incident angle of 30° is 6.5 or less.

(5) The anti-reflective laminate according to any one of the above (1) to (4), having a luminous reflectance (SCI Y) of 0.9% or less.

### EXAMPLES

Hereinafter, the present invention is described in detail with reference to Examples, but the present invention is not limited thereto. Example 1 to Example 4 are Inventive Examples, and Example 5 to Example 7 are Comparative Examples.

### Example 1

A glass substrate (AS glass (soda glass), thickness: 2 mm, refractive index: 1.52) was charged into a vacuum chamber, which was evacuated until the pressure reached 1×10⁻⁴ Pa, and the following first refractive index layer to fourth refractive index layer were formed in order. Note that, the refractive index of each refractive index layer shown below is determined based on the spectral transmittance and the spectral reflectance by assuming that the wavelength dispersion is of the Cauchy type, and is a value at a wavelength of 550 nm. Specifically, assuming that the refractive index of the film is of the form n=A0+A1/λ2+A2/λ(λ is the wavelength of light), A0 to A2 were determined such that a residual sum of squares between the measured and calculated values of the spectral transmittance and the spectral reflectance at wavelengths of 380 nm to 780 nm was minimized. A0, A1 and A2 are each a fitting parameter.

### <First Refractive Index Layer>

A layer made of a silicon oxide [silica (SiO₂)] having a predetermined thickness was formed by DC magnetron sputtering using a silicon target in a digital sputtering method while maintaining the pressure at 0.2 Pa with an argon gas. Note that, after the metal film was formed, oxidation was performed using oxygen plasma to form a layer made of an oxide. The first refractive index layer had a thickness of 83.8 nm and a refractive index of 1.455.

### <Second Refractive Index Layer>

A mixed layer of a silicon oxide [silica (SiO₂)] and a titanium oxide [titania (TiO₂)] having a predetermined thickness was formed by DC magnetron sputtering using a silicon target and a titanium target in a digital sputtering method while maintaining the pressure at 0.2 Pa with an argon gas. The ratio (silicon oxide/titanium oxide) of the silicon oxide [silica (SiO₂)] to the titanium oxide [titania (TiO₂)] was within the range of 0.1 to 0.9 on a mass basis. Note that, after the metal film was formed, oxidation was performed using oxygen plasma to form a layer made of an oxide. At this time, the mixture ratio of the metal film was changed to change the ratio of the oxide formed by the oxygen plasma. The second refractive index layer had a thickness of 70.8 nm and a refractive index of 1.710.

### <Third Refractive Index Layer>

A layer made of a titanium oxide [titania (TiO₂)] having a predetermined thickness was formed by DC magnetron sputtering using a titanium target in a digital sputtering method while maintaining the pressure at 0.2 Pa with an argon gas. Note that, after the metal film was formed, oxidation was performed using oxygen plasma to form a layer made of an oxide. The third refractive index layer had a thickness of 98.1 nm and a refractive index of 2.429.

### <Fourth Refractive Index Layer>

A layer made of a silicon oxide [silica (SiO₂)] having a predetermined thickness was formed by DC magnetron sputtering using a silicon target in a digital sputtering method while maintaining the pressure at 0.2 Pa with an argon gas. Note that, after the metal film was formed, oxidation was performed using oxygen plasma to form a layer made of an oxide. The fourth refractive index layer had a thickness of 81.6 nm and a refractive index of 1.455.

In this manner, an anti-reflective laminate in Example 1 shown in Table 1 was prepared.

### Example 2 to Example 4

Anti-reflective laminates in Examples 2 to 4 were prepared in the same manner as in Example 1, except that the film-forming times of the first to fourth refractive index layers in Example 1 were changed to obtain the refractive index and the thickness shown in Table 1.

### Example 5

ReaLook (registered trademark) 1800 (manufactured by NOF Corporation) was used as an anti-reflective laminate in Example 5. The ReaLook (registered trademark) 1800 includes an anti-reflective layer made of a 100 nm thick low refractive index layer (one layer) formed by wet coating (wet method) on a 100 μm thick PET film.

### Example 6

On a 40 μm thick triacetyl cellulose (TAC) substrate provided with a 5 μm thick acrylic hard coat layer on one surface, a silicon oxynitride (SiNₓO_{y}) as an adhesion layer was deposited on a hard coat layer side in order to reduce the influence of degassing, the substrate was charged into a vacuum chamber, which was evacuated until the pressure reached 1×10⁻⁴ Pa, and the following first refractive index layer to fourth refractive index layer were formed in order. Note that, the refractive index of each refractive index layer shown below is determined based on the spectral transmittance and the spectral reflectance by assuming that the wavelength dispersion is of the Cauchy type, and is a value at a wavelength of 550 nm. Specifically, assuming that the refractive index of the film is of the form n=A0+A1/λ2+A2/λ4 (λ is the wavelength of light), A0 to A2 were determined such that a residual sum of squares between the measured and calculated values of the spectral transmittance and the spectral reflectance at wavelengths of 380 nm to 780 nm was minimized. A0, A1 and A2 are each a fitting parameter.

### <Low Refractive Index Layers (Second and Fourth Refractive Index Layers)>

As the second and fourth refractive index layers, a layer made of a silicon oxide [silica (SiO₂)] having a predetermined thickness was formed by DC magnetron sputtering using a silicon target in a digital sputtering method while maintaining the pressure at 0.2 Pa with an argon gas. Note that, after the metal film was formed, oxidation was performed using oxygen plasma to form a layer made of an oxide.

### <High Refractive Index Layers (First and Third Refractive Index Layers)>

As the first and third refractive index layers, a layer made of a titanium oxide [titania (TiO₂)] having a predetermined thickness was formed by DC magnetron sputtering using a titanium target in a digital sputtering method while maintaining the pressure at 0.2 Pa with an argon gas. Note that, after the metal film was formed, oxidation was performed using oxygen plasma to form a layer made of an oxide.

In this manner, an anti-reflective laminate in Example 6 shown in Table 1 was prepared.

### Example 7

An anti-reflective laminate in Example 7 was prepared in the same manner as in Example 6, except that the film-forming times of the first to fourth refractive index layers in Example 6 were changed to obtain the thickness shown in Table 1.

For the anti-reflective laminate in each example, the luminous reflectance (SCI Y), and the chromaticity coordinates a*, b*, the color difference ΔE, and the maximum value of the distance from the chromaticity coordinate origin to the chromaticity coordinate of the reflected light for an incident angle of 7° and an incident angle of 30° were determined using the method described below. The results are shown in Table 1.

### <Luminous Reflectance (SCI Y)>

The spectral reflectance was measured using a spectrophotometer (trade name: SolidSpec-3700 manufactured by Shimadzu Corporation), and the luminous reflectance (reflection stimulus value Y: SCI Y specified in JIS Z 8701 (1999)) was determined by calculation. Note that, during the measurement, a black tape (“KUKKIRI MIERU” manufactured by TOMOEGAWA CORPORATION, diffusion reflectance was equivalent to approximately 0.01% in SCE Y under a D65 light source) was attached to a back surface side (substrate side) of the anti-reflective laminate to eliminate reflection on the other main surface.

### <Chromaticity Coordinate a* of Reflected Light at Incident Angle of 7° and Incident Angle of 30°>

A black tape (“KUKKIRI MIERU” manufactured by TOMOEGAWA CORPORATION, diffusion reflectance was equivalent to approximately 0.01% in SCE Y under a D65 light source) was attached to a back surface side (substrate side) of the anti-reflective laminate. Accordingly, a light source was incident on the front surface side (anti-reflective layer side) of the anti-reflective laminate at an incident angle of 7° and an incident angle of 30° while eliminating the reflection on the other main surface. According to the method specified in JIS Z 8722 (2009), the spectral reflectance was measured using a spectrocolorimeter (trade name: CM-26d manufactured by Konica Minolta, Inc.), and the chromaticity coordinate a* of the reflected light was determined by calculation.

<Color Difference ΔE between Reflected Lights at Incident Angle of 7° and Incident Angle of 30°>

A black tape (“KUKKIRI MIERU” manufactured by TOMOEGAWA CORPORATION, diffusion reflectance was equivalent to approximately 0.01% in SCE Y under a D65 light source) was attached to a back surface side (substrate side) of the anti-reflective laminate. Accordingly, a light source was incident on the front surface side (anti-reflective layer side) of the anti-reflective laminate at an incident angle of 7° and an incident angle of 30° while eliminating the reflection on the other main surface. According to the method specified in JIS Z 8722 (2009), the spectral reflectance was measured using a spectrocolorimeter (trade name: CM-26d manufactured by Konica Minolta, Inc.), the chromaticities L*, a* and b* of the reflected light were determined by calculation, and the color difference ΔE between the reflected lights at an incident angle of 7° and an incident angle of 30° was determined according to the following equation (1).

$$Color difference Δ E = {[ {( {L}_{1}^{*} - {L}_{2}^{*} )}^{2} + {( {a}_{1}^{*} - {a}_{2}^{*} )}^{2} + {( {b}_{1}^{*} - {b}_{2}^{*} )}^{2} ]}^{1 / 2} \qquad Equation ( 1 )$$

In the above equation (1), L₁*, a₁*, and b₁* respectively mean the chromaticities L*, a*, and b* of the reflected light at an incident angle of 30°. In the above equation (1), L₂*, a₂*, and b₂* respectively mean the chromaticities L*, a*, and b* of the reflected light at an incident angle of 7°.

<Maximum Value of Distances from Chromaticity Coordinate Origin to Chromaticity Coordinates of Reflected Lights at Incident Angle of 7° and Incident Angle of 30°>

A black tape (“KUKKIRI MIERU” manufactured by TOMOEGAWA CORPORATION, diffusion reflectance was equivalent to approximately 0.01% in SCE Y under a D65 light source) was attached to a back surface side (substrate side) of the anti-reflective laminate. Accordingly, a light source was incident on the front surface side (anti-reflective layer side) of the anti-reflective laminate at an incident angle of 7° and an incident angle of 30° while eliminating the reflection on the other main surface. According to the method specified in JIS Z 8722 (2009), the spectral reflectance was measured using a spectrocolorimeter (trade name: CM-26d manufactured by Konica Minolta, Inc.), the chromaticity coordinates (a*, b*) of the reflected light were determined by calculation, and the distance 1 (a₁*²+b₁*²)^{1/2} from the chromaticity coordinate origin to chromaticity coordinates (a₁*, b₁*) of the reflected light at an incident angle of 30° and the distance 2 (a₂*²+b₂*²)^{1/2} from the chromaticity coordinate origin to chromaticity coordinates (a₂*, b₂*) of the reflected light at an incident angle of 7° were determined. As a result, the larger one of the distance 1 and the distance 2 was determined as the maximum value of the distance from the chromaticity coordinate origin to the chromaticity coordinates of the reflected light at an incident angle of 7° and an incident angle of 30°.

TABLE 1

| | | | | | | | | | | Color | Maximum value |
|---|---|---|---|---|---|---|---|---|---|---|---|
| | | | | | | | | | | difference | of distance from |
| | | Film configuration | | | | | | | | ΔE | SCI chromaticity |
| | | Adhesion | First | Second | Third | Fourth | Specular reflection properties | | | between | coordinate |
| | Substrate | layer | layer | layer | layer | layer | SCIY (%) | a* | b | 7° and 30° | origin (7°, 30°) |
| Example | Soda | — | n = 1.455 | n = 1.710 | n = 2.429 | n = 1.455 | 0.175 | 1.6 | −2.14 | 2.85 | 2.53 |
| 1 | glass | | 83.8 nm | 70.8 nm | 98.1 nm | 81.6 nm | | | | | |
| Example | Soda | — | n = 1.455 | n = 1.710 | n = 2.429 | n = 1.455 | 0.115 | 1.79 | −1.89 | 1.73 | 3.90 |
| 2 | glass | | 99.5 nm | 68.5 nm | 96.4 nm | 87.3 nm | | | | | |
| Example | Soda | — | n = 1.455 | n = 1.706 | n = 2.429 | n = 1.455 | 0.173 | −0.05 | −0.45 | 2.86 | 4.48 |
| 3 | glass | | 49.7 nm | 72.4 nm | 101.1 nm | 85.3 nm | | | | | |
| Example | Soda | — | n = 1.455 | n = 1.725 | n = 2.429 | n = 1.455 | 0.174 | 1.24 | −2.03 | 2.83 | 5.36 |
| 4 | glass | | 49.3 nm | 74.8 nm | 104.2 nm | 85.3 nm | | | | | |
| Example | PET film | — | — | — | — | — | 0.25 | 4.91 | −9.24 | 4.94 | 10.82 |
| 5 | | | | | | | | | | | |
| Example | TAC | SiN | n = 2.429 | n = 1.455 | n = 2.429 | n = 1.455 | 0.19 | 1.24 | −4.29 | 4.18 | 8.07 |
| 6 | | 15 nm | 6.1 nm | 34.3 nm | 105.5 nm | 87.4 nm | | | | | |
| Example | TAC | SiN | n = 2.429 | n = 1.455 | n = 2.429 | n = 1.455 | 0.23 | 1.79 | 5.47 | 4.07 | 6.87 |
| 7 | | | | | | | | | | | |

As can be seen from the results in Table 1, since the anti-reflective layer has a four-layer structure including a first refractive index layer to a fourth refractive index layer and the refractive index and the thickness of each refractive index layer are within predetermined ranges of the present invention in Example 1 to Example 4, the chromaticity coordinate a* of the reflected light at an incident angle of 7° and an incident angle of 30° can be 2.0 or less, the color difference ΔE between the reflected lights at an incident angle of 7° and an incident angle of 30° can be 4.0 or less, and the maximum value of the distances (a*²+b*²)^{1/2} from the chromaticity coordinate origin to the chromaticity coordinates (a*, b*) of the reflected lights at incident angle of 7° and an incident angle of 30° can be 6.5 or less. That is, according to the configuration of the present invention, an anti-reflective laminate having a reduced angle-dependent change in reflection color and having high designability could be provided.

On the other hand, in Example 5, the chromaticity coordinate a* of the reflected light at an incident angle of 7° and an incident angle of 30° is more than 2.0, the color difference ΔE between the reflected lights at an incident angle of 7° and an incident angle of 30° is more than 4.0, and the maximum value of the distances (a*²+b*²)^{1/2} from the chromaticity coordinate origin to the chromaticity coordinates (a*, b*) of the reflected lights at incident angle of 7° and an incident angle of 30° is more than 6.5. In this way, in Example 5, the angle-dependent change in reflection color could not be sufficiently reduced.

In Example 6 and Example 7, since the refractive index includes only two types of layers, a high refractive index layer and a low refractive index layer, the color difference ΔE between the reflected lights at an incident angle of 7° and an incident angle of 30° is more than 4.0, and the maximum value of the distances (a*²+b*²)^{1/2} from the chromaticity coordinate origin to the chromaticity coordinates (a*, b*) of the reflected lights at incident angle of 7° and an incident angle of 30° is more than 6.5. In this way, in Example 6 and Example 7, the angle-dependent change in reflection color could not be sufficiently reduced either.

The present application is based on Japanese Patent Application No. 2023-186576 filed on Oct. 31, 2023, the contents of which are incorporated herein by reference.

What is claimed is:

1. An anti-reflective laminate comprising:
a substrate; and
an anti-reflective layer laminated on the substrate and having a four-layer structure comprising a first refractive index layer, a second refractive index layer, a third refractive index layer, and a fourth refractive index layer in order from a substrate side,
wherein the first refractive index layer has a refractive index of 1.25 to 1.50, the second refractive index layer has a refractive index of 1.50 to 2.40, the third refractive index layer has a refractive index of 2.25 to 2.45, and the fourth refractive index layer has a refractive index of 1.25 to 1.50, and
the first refractive index layer has a thickness of 40 nm to 105 nm, the second refractive index layer has a thickness of 60 nm to 90 nm, the third refractive index layer has a thickness of 80 nm to 110 nm, and the fourth refractive index layer has a thickness of 70 nm to 100 nm.

2. The anti-reflective laminate according to claim 1, wherein the second refractive index layer comprises a silicon oxide and a titanium oxide.

3. The anti-reflective laminate according to claim 1, wherein a chromaticity coordinate a* of reflected light at an incident angle of 7° and an incident angle of 30° is 2.0 or less, and a color difference ΔE between reflected lights at an incident angle of 7° and an incident angle of 30° is 4.0 or less.

4. The anti-reflective laminate according to claim 1, wherein a chromaticity coordinate a* of reflected light at an incident angle of 7° and an incident angle of 30° is 2.0 or less, and a maximum value of distances (a*²+b*²)^{1/2} from a chromaticity coordinate origin to chromaticity coordinates (a*, b*) of reflected lights at an incident angle of 7° and an incident angle of 30° is 6.5 or less.

5. The anti-reflective laminate according to claim 1, having a luminous reflectance (SCI Y) of 0.9% or less.
